(19) United States
(12) Patent Application Publication
(10) Pub. No.: US 2024/0166481 A1
(43) Pub. Date: May 23, 2024

(54) LIFTING MECHANISM FOR LIFT TABLE

(71) Applicant: City Commerce Ltd., Tochigi (JP)

(72) Inventor: Toshihiro Takeuchi, Tochigi (JP)

(73) Assignee: City Commerce Ltd., Tochigi (JP)

(21) Appl. No.: 18/513,212

(22) Filed: Nov. 17, 2023

(30) Foreign Application Priority Data
Nov. 21, 2022 (JP) 2022-185392

(51) Int. Cl. B66F 7/06

(52) U.S. Cl. CPC B66F 7/065

(57) ABSTRACT

A lifting mechanism includes: a base being bottom of the lifting mechanism; a table; a lifting unit lifts up the table, the lifting unit being a cam structure, the lifting unit includes a first inclined portion and a cam portion; a pedestal; a driver moves the pedestal in a horizontal direction; and a regulator restricts a movement of the table. The table is lifted according to a relative position between an inclined surface of the first inclined portion and the cam portion. The first inclined portion or the cam portion is located at a bottom of the table, and the corresponding cam or the inclined portion is located at the pedestal. The relative position between the inclined surface of the first inclined portion and the cam portion is changed by a movement of the pedestal in the horizontal direction.

### CROSS-REFERENCE TO RELATED APPLICATION(S)

This application is based on and claims priority under 35 USC 119 from Japanese Patent Application No. 2022-185392 filed on Nov. 21, 2022, the contents of which are incorporated herein by reference.

### TECHNICAL FIELD

The present invention relates to an apparatus for lifting items such as cargo, and in particular, to a technology of a low-height table type and a compact sized lifting mechanism for lifting.

### BACKGROUND ART

Various structures have been developed as mechanisms for lifting and lowering items such as cargo.

Some of these are used as mechanisms to lift and lower underfloor storage units.

For example, one such mechanism is to lift and lower the storage units with a wire.

However, in the case of the wire type, a structure for winding up the wire is placed around the storage unit, so a larger area than the storage unit is needed for installation.

In addition, when using an X-arm structure that lifts and lowers, the height under the floor is limited, so the lift table requires a low-height table type.

In order to have a low height, a technology is known to provide an inclined portion on an arm and to assist the initial ascent by a cam mechanism with the inclined portion and a cam. However, the structure is designed to attach the inclined portion to the arm, and the attachment position of the inclined portion to the arm is uniquely determined by the amount to be lifted by the cam. This has been a design limitation for structures that lift and lower relatively small storage units.

Therefore, a simple structure that is not larger than the area of the storage unit when viewed from the top, the structure has a low-height table, and the structure has few restrictions when designing the lifting structure is required.

Various technologies have been proposed to address these problems.

For example, a pantograph-type lift table (see Patent Literature 1) has been proposed and has become a publicly known technology.

More specifically, the pantograph-type lift table technology consists of a cam mechanism that pushes up an arm members which includes an inclined portion attached to the pantograph and performs an initial lifting operation of the pantograph, following the initial lifting, the pantograph is lifted by moving one support point of the pantograph toward the other support point.

However, the structure according to this prior art does not solve the problem of the present invention, since the initial cam structure has a shape that protrudes from an area of a loading table when viewed from above.

### CITATION LIST

### Patent Literature

Patent Literature 1: JP1995-187587A

### SUMMARY

Therefore, the present invention relates to provide a lifting mechanism with a simple structure that is no larger than an area of the storage unit from the top view, with a low table, and with few restrictions when designing the lift table.

A lifting mechanism for lift table according to one aspect of the present invention includes:
a base being bottom of the lifting mechanism;
a table;
a lifting unit configured to lift up and lower the table, the lifting unit being a cam structure, the lifting unit including a first inclined portion and a cam portion;
a pedestal;
a driver configured to move the pedestal in a horizontal direction; and
a regulator configured to restrict a movement of the table in the horizontal direction, wherein
the table is lifted and lowered according to a relative position between an inclined surface of the first inclined portion and the cam portion,
the first inclined portion or the cam portion is located at a bottom of the table, and the corresponding cam or the inclined portion is located at the pedestal, and
   the relative position between the inclined surface of the first inclined portion and the cam portion is changed by a movement of the pedestal in the horizontal direction.

According to the lifting mechanism for lift table of present invention, the structure is simple and easy to install as residential equipment, and the structure is not larger than the area of the storage unit when viewed from above, so it facilitates construction. In addition, the degree of freedom in designing the lifting structure can be increased.

### BRIEF DESCRIPTION OF DRAWINGS

FIG. 1 is an overall view of an embodiment of the lifting mechanism according to the present invention.

FIGS. 2A and 2B are schematic diagrams showing an embodiment of the lifting mechanism in an underfloor storage unit according to the present invention.

FIGS. 3A to 3C are cross-sectional views of an embodiment of a lifting mechanism according to the present invention.

FIGS. 4A to 4C are top views of an embodiment of a lifting mechanism according to the present invention.

FIGS. 5A and 5B are illustration of modifications of the guide rail of the lifting mechanism according to the present invention.

FIGS. 6A to 6D are embodiments of the cam structure of the lifting mechanism according to the present invention.

FIGS. 7A to 7D are oblique views of other embodiments of the inclined portion of the lifting mechanism according to the present invention.

FIGS. 8A to 8E are side schematic views showing other embodiments of the lifting mechanism according to the present invention.

FIGS. 9A to 9E are cross-sectional views of other embodiments of the lifting mechanism according to the present invention.

FIGS. 10A to 10D are side schematic views showing other embodiments of the lifting mechanism according to the present invention.

FIGS. 11A and 11B are schematic views of other embodiments of the lifting mechanism according to the present invention.

FIG. 12 is an overall view of another embodiment of the lifting mechanism according to the present invention.

FIGS. 13A to 13C are side cross-sectional views of other embodiments of the lifting mechanism according to the present invention.

FIGS. 14A to 14C are top views of other embodiments of the lifting mechanism according to the present invention.

FIGS. 15A and 15B are graphs show a relationship between load and table height in the lifting mechanism according to the present invention.

### DESCRIPTION OF EMBODIMENTS

The main feature of the lifting mechanism of the present invention is a structure that is not larger than an area of the storage unit when viewed from top, and that is a low-height table structure, with few restrictions when designing the lifting mechanism.

The following is descriptions of embodiments of the lifting mechanism for the present invention based on the drawings.

The overall shape of the lifting mechanism and the shape of each part shown below are not limited to the embodiments described below but can be changed as needed within the scope of the technical concept of the present invention, i.e., the shape and dimensions, etc. that can achieve the same action effect.

### Embodiment 1

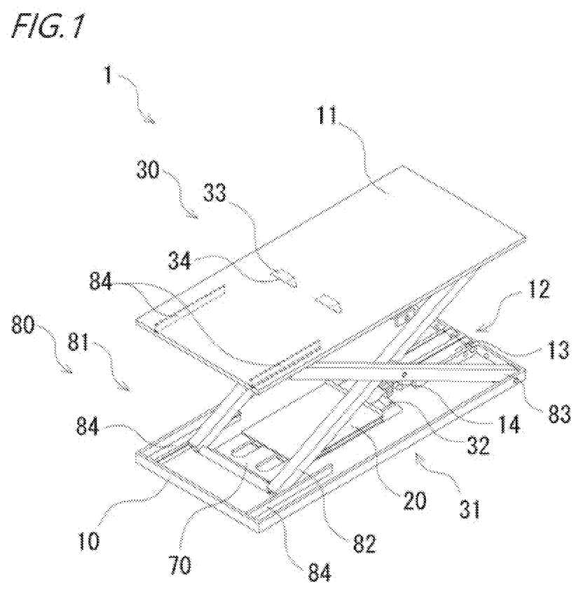

The present invention is described according to FIGS. 1 to 6A, 15A and 15B.

FIG. 1 is an overall view of an embodiment of the lifting mechanism.

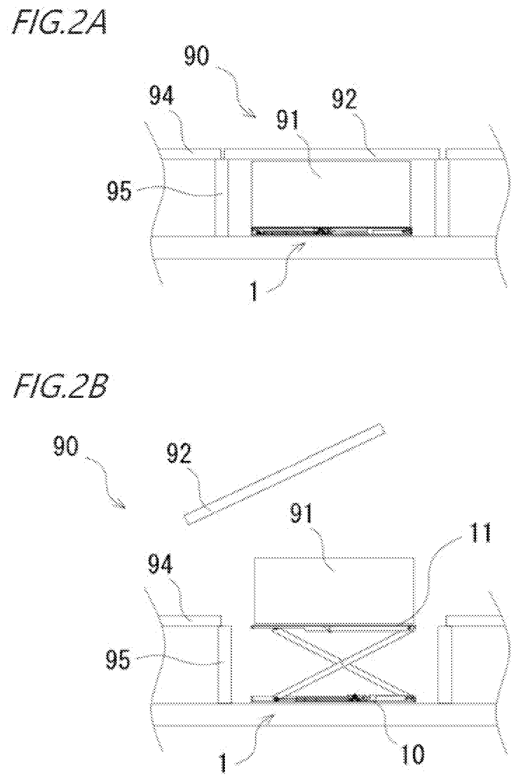

FIGS. 2A and 2B are schematic diagrams showing an embodiment of the lifting mechanism in an underfloor storage unit, FIG. 2A showing the lowest position of the lifting mechanism and FIG. 2B showing the highest position of the lifting mechanism.

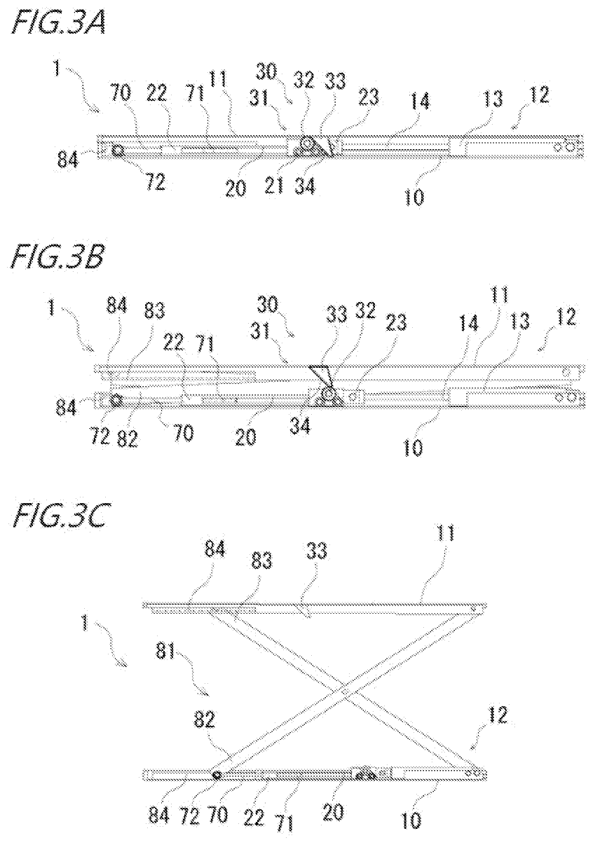

FIGS. 3A to 3C are cross-sectional views showing an embodiment of the lifting mechanism, FIG. 3A showing the lowest position of the lifting mechanism, FIG. 3B showing the table lifted by the cam structure of the lifting mechanism, and FIG. 3C showing the highest position of the lifting mechanism.

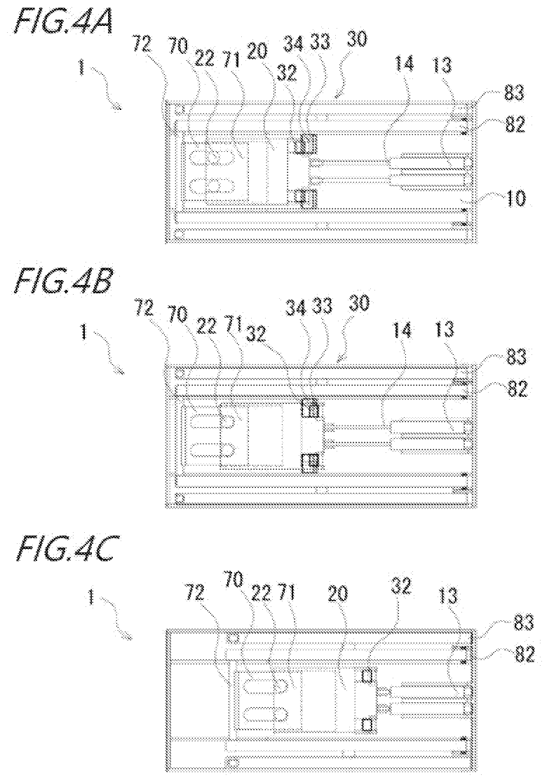

FIGS. 4A to 4C show top views of the lifting mechanism for the present invention, excluding the table, FIG. 4A shows the lowest position of the lifting mechanism, FIG. 4B shows the table lifted by the cam structure of the lifting mechanism, and FIG. 4C shows the highest position of the lifting mechanism.

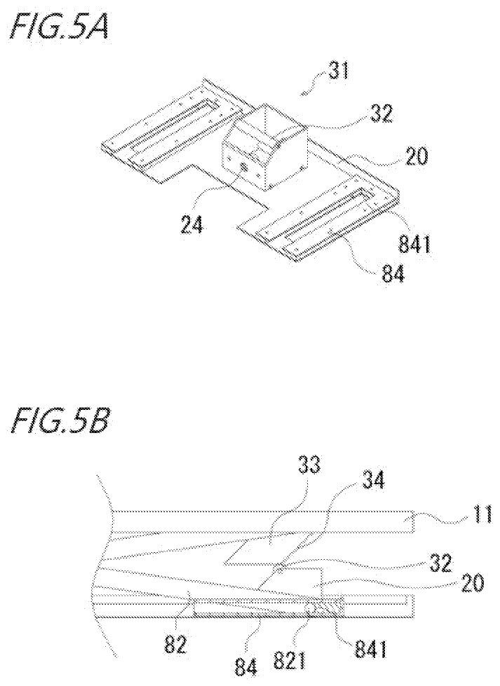

FIGS. 5A and 5B show modifications of the guide rail of the lifting mechanism, FIG. 5A is a diagonal view of a pedestal with the guide rail, and FIG. 5B is a side cross-sectional view showing an operation of the guide rail.

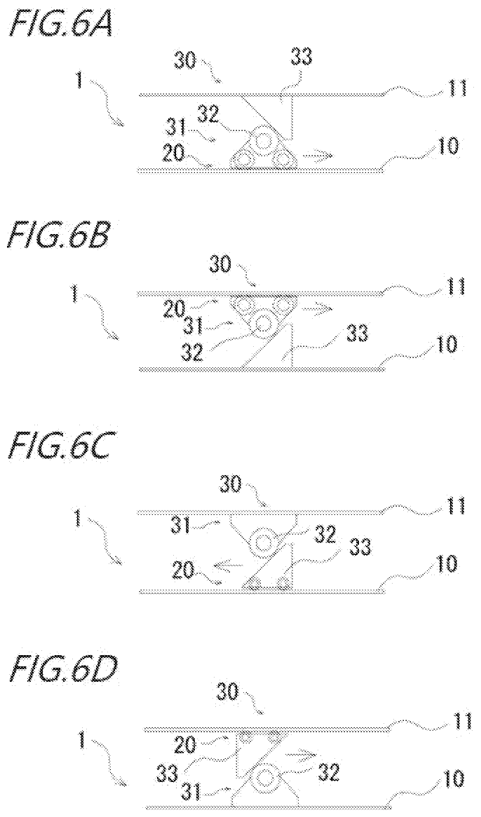

FIGS. 6A to 6D show embodiments of the cam structure of the lifting mechanism, showing variations of cams and inclined potions.

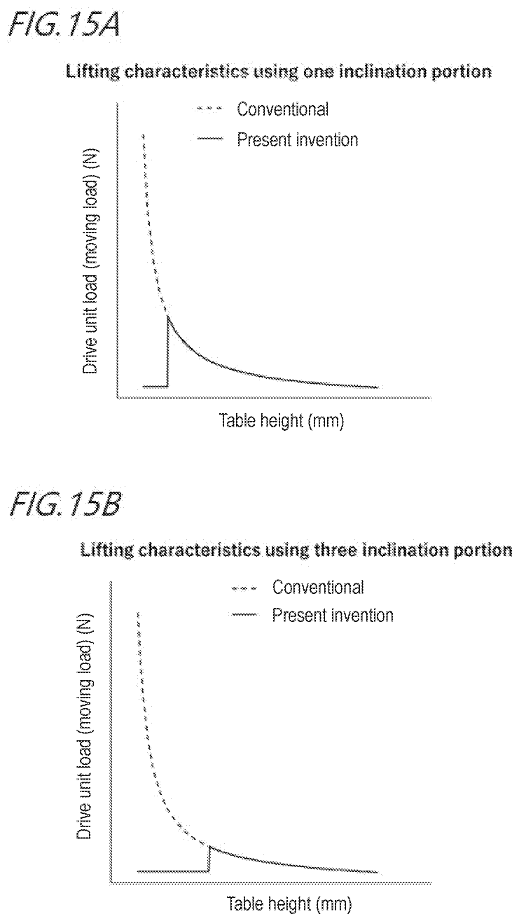

FIGS. 15A an 15B are graphs showing a relationship between load and table height in the lifting mechanism.

The lifting mechanism (in other term, lift table) 1 is a device that lifts and lowers cargo and other items. Lifting and lowering at a lower position is performed by the operation of the inclined portion and cam portion, while lifting and lowering at the higher position is performed by extending and retracting a X-arms.

The lift table 1 consists of a base (base unit) 10, a table (table unit) 11, a lifting unit 30, a pedestal 20, a driver (drive unit) 12, a regulator (regulatory portion) 80, and a link portion 70.

### Relating the Base (the Base Unit)

Base unit 10 is the base of the lift table 1 and the bottom portion of the lift table 1. The base unit 10 is similar in shape to the table unit 11 and is generally rectangular.

The drive unit 12, pedestal 20, and regulatory portion 80 are located on the base unit 10. Since large horizontal and vertical forces may be applied to the drive unit 12, pedestal 20, and regulatory portion 80 when lifting and lowering, it is suitable if the base unit 10 is made of a rigid material.

The top surface of the base unit 10 is flat, since the pedestal 20 moves horizontally over 15 the base unit 10. A lifted portion may be provided around the base unit 10 to secure the edge of the regulatory portion 80.

### Regarding the Table (Table Unit)

The table unit 11 is the part that receives and supports cargo and other items. In the case of an underfloor storage unit, it holds cargo unit 91. It must be rigid enough to withstand the load of the cargo, etc. The shape is generally rectangular and tray-like as a whole. The table unit 11 is regulated in the horizontal direction by regulatory portion 80 and can only be moved in the vertical direction.

The first inclined portion 33 including the lifting unit 30 is located at the bottom of the table unit 11. The first inclined portion 33 is in a position corresponding to the cam portion 31. The first inclined portion 33 includes an inclined surface 34 located at a position corresponding to the cam portion 33. An angle of the inclined surface 34 is determined by an amount of load of the load and a force of the drive unit 12. For example, the angle is 45 degrees.

In lifting and lowering table unit 11 at a low position level, the table unit 11 is lifted and lowered by a biasing force of a cylindrical portion 32 of the cam portion 31 against the inclined surface 34. In this process, the load of the cargo and table unit 11 is applied to the inclined surface 34, so the first inclined portion 33 must be rigid enough to withstand the load.

The first inclined portion 33 can be one or more than one. More than one is more suitable for distributing the load.

### Regarding the Lifting Unit

Lifting unit 30 is a portion that lifts and lowers table unit 11 when lift table 1 is in a low position. The lifting unit 30 includes a cam portion 31 and a first inclined portion 33.

The lifting unit 30 is a cam structure. The cam structure is a structure in which a direction of motion is changed by two components. In the cam structure, a side that transmits motion is called a driver node, and a side that receives motion and performs work is called a follower node.

In this embodiment, the cam portion 31 is the driver node and the first inclined portion 33 is the follower node.

The cam portion 31 is mounted on the pedestal 20 and moves horizontally with the pedestal 20 by the force of the drive unit 12. The cam portion 31 has a cylindrical portion 32. The cylindrical portion 32 contacts the inclined surface 34 of the first inclined portion 33 and generates an upward force on the first inclined portion 33 by applying a biasing force against the inclined surface 34.

In this embodiment, the cam shape of the cam portion 31 is cylindrical, but it can be any other shape as long as it can move smoothly against the corresponding inclined surface 34 while applying force. For example, it can be a rotatable wheel shape or a slope shape corresponding to the inclined surface 34.

It is conceivable that the X-arm could be lifted and lowered by moving the axis of one end of the X-arm in the horizontal direction, without using the cam structure. However, there is a relationship between an arm angle, i.e., the table height on the horizontal axis, and the drive load, as shown in the conventional embodiment in FIG. 15A. When the arm angle, i.e., the table height on the horizontal axis, is less than a certain range, the load increases dramatically, making it difficult to drive. Therefore, the cam structure is required.

The first inclined portion 33 is the portion that obtains the upward force by the cam portion 31. The first inclined portion 33 is located at the bottom of table unit 11. The cylindrical portion 32 of the cam portion 31 contacts and attaches to the inclined surface 34 of the first inclined portion 33, thereby applying a vertical force to the face of the inclined surface 34. The force is broken down into a vertical upward force and a horizontal force. The horizontal force is regulated by the regulatory portion 80, and the vertical upward force causes table unit 11 to move upward.

If the angle of the inclined surface 34 is close to horizontal, the amount of rise of the table unit 11 relative to the amount of movement of the cam portion 31 will be small, and the driving force by the drive portion 12 can be relatively small. However, the amount of movement of the cam portion 31 relative to the amount of ascent will be larger.

If the angle of the inclined surface 34 is close to vertical, the amount of ascent of the table unit 11 relative to the amount of movement of the cam portion 31 is larger, and the driving force is relatively larger by the drive unit 12. The amount of movement of the cam portion 31 relative to the amount of ascent can be small.

The angle of the inclined surface 34 would be determined according to the driving force, the amount of ascent required, and the speed of ascent.

When table unit 11 is in the lowest position, the first inclined portion 33 may be in contact with the base unit 10. In this condition, when in the lowest position, the cargo, and other items are supported by the base unit 10, the first inclined portion 33, and the table unit 11, which reduces the load on the shafts and other parts of the other regulatory portion 80.

When used for underfloor storage, table unit 11 is in the lowest position most of the time, so the first inclined portion 33 can be in contact with base unit 10 to reduce the load on the other regulatory portion 80, etc.

### Regarding the Pedestal (Pedestal Unit)

The pedestal 20 is the part that moves the cam portion 31 and lifts and lowers the telescopic arm 81 via the link portion 70.

The pedestal 20 has wheel 21 and can move smoothly and horizontally on the base unit 10. The pedestal 20 has a tow portion 23. The tow portion 23 is connected to the end of the piston 14 of the drive unit 12. The tow portion 23 transmits the force of the piston 14 of the drive unit 12 to the pedestal 20.

The cam portion 31 is integrally located at the top of the pedestal 20.

A pedestal-side connection 22 side of the pedestal 20 is the part that works with the link portion 70 and is shaped as a whole, sandwiched between two upper and lower plates, with two pedestal-side connection 22s placed in the gap between the two plates.

The pedestal 20 and the link portion 70 are connected loosely fit by the pedestal-side connection 22 and the link-side connection portion 71. When the pedestal 20 moves away from the link portion 70 to a certain extent or more, the pedestal-side connection 22 of the pedestal 20 and the link-side connection portion 71 of the link portion 70 are connected, and the pedestal 20 lifts and lowers the telescopic arm 81 via the link portion 70.

### Regarding the Driver (Drive Unit)

The drive unit 12 is a part that generates the force to lift and lower the lift table 1 and moves the pedestal 20 horizontally. The drive unit 12 is a hydraulic cylinder drive system. It consists of a cylinder 13 and a piston 14. Oil supplied from a hydraulic pump (not shown) is fed into cylinder 13 to move the piston 14 and generate the driving force.

Other possible drive methods include screw drive, wire drive, and air drive.

The screw drive is driven by a screw and a motor that rotates the screw. The screw drive actuator allows the arm to move a larger distance and the table to be lifted to a higher height. The wire drive is driven by a wire, a reel that winds the wire, and a motor that rotates the reel. The air drive is driven by an air pump and corresponding cylinder and piston.

### Regarding the Regulator (Regulatory Portion)

Regulatory portion 80 regulates the horizontal movement of table unit 11 and allows table unit 11 to move only in the vertical direction. The regulating portion is located at the bottom of the table unit 11.

In this embodiment, an X-arm type telescopic arm 81 is used. The telescopic arm 81 has the function of regulating the horizontal movement of the table unit 11 and elevating the table unit when there is an angle between the arms.

The telescopic arm 81 is structured with a first lift arm 82 and a second lift arm 83 mutually rotatably connected between the base unit 10 and the table unit 11.

One end of the first and second lift arms is movable in the horizontal direction by means of guide rail 84 (hereinafter referred to as the moving end). The guide rail 84 prevents only table unit 11 from being lifted when table unit 11 is lifted by the lifting unit 30 and allows the first and second lift arms to follow the movement of table unit 11 and change the angle between the arms to a predetermined angle.

Link portion 70 is connected to the end of the first lift arm 82, and the link portion 70 is moved by the pedestal 20, causing the telescopic arm 81 to extend and retract vertically.

As another structure, the regulatory portion 80 may be a cylinder structure 85 that can extend and retract only in the vertical direction. By using a cylinder structure 85, the lifting and lowering by the lifting unit 30 can be performed smoothly.

Also, by attaching the guide rail 84 to the pedestal 20, the lift arm can be prevented from lifting unnecessarily. An embodiment of the shape is shown in FIG. 5A. The guide rail 84 is provided on both sides of the pedestal 20 to correspond to the first lift arm 82. The guide rail 84 has grooves dug in the direction in which the moving ends of the lift arms move. In the center of the pedestal 20, there is a threaded screw hole 24 for the screw drive.

The operation is described along FIG. 5B.

Along the horizontal groove of the guide rail 84, the moving end of the first lift arm 82, the lift arm shaft portion 821, moves horizontally. The guide rail 84 prevents the moving end of the first lift arm 82 from being lifted when table potion 11 is lifted by the lifting unit 30.

The guide rail 84 also functions as the link portion 70, eliminating the need for the link portion 70 and simplifying the structure.

Specifically, the structure is such that when the pedestal 20 moves beyond a certain degree, the moving end of the first lift arm 82 contacts the end of the guide rail 84, and the moving end is moved according to the movement of the pedestal 20.

When the table unit 11 is in the lowest position, among the ends of the guide rail 84, the guide rail end 841, which is the end farthest from the drive unit 12, and the lift arm shaft portion 821 are not in contact with each other. Therefore, the guide rail end 841 can move within the guide rail 84 without restriction.

When the lifting operation of table 11 by the lifting unit 30 is completed, the guide rail end 841 and the lift arm shaft portion 821 are connected (FIG. 5B). Therefore, the guide rail end 841 and the lift arm shaft portion 821 move as one unit, and the pedestal 20 and the lift arm shaft portion 821 move as one unit.

As a result, the movement of the pedestal 20 causes the telescopic arm 81 to extend and retract vertically.

Thus, without using the link potion 70, the lift arm end does not move while the lifting unit 30 is operating, and the lift arm end can begin moving after the lifting unit 30 has completed its operation, allowing the telescopic arm 81 to be lifted and lowered efficiently.

This type of structure is also suitable for structures with a fixed drive potion, as there is no angular change in a pull point of the drive potion 12 relative to the pedestal 20.

The number of parts can be reduced by eliminating the link potion 70 or incorporating the guide rail 84 into the pedestal 20, thereby improving productivity and reducing costs.

In addition, fewer parts can be placed on the base unit 10, which means that relatively more important parts are located on top of the equipment, making assembly, installation, and maintenance work easier as an underfloor storage unit.

### Regarding the Link Portion

The link portion 70 is a structure for connecting the telescopic arm 81 to the pedestal 20, depending on a distance between the telescopic arm 81 and the pedestal 20.

One end of the link portion 70 is a shaft portion 72, which is connected to the shafts at the ends of the pair of first lift arm 82. The link portion 70 as a whole is one planar plate and has two holes, the link-side connection portion 71, through which the pedestal-side connection 22 passes, and the pedestal 20 and link portion 70 are loosely fitted together by the link-side connection portion 71 and the pedestal-side connection 22.

When the table unit 11 is in the lowest position, that is, when the pedestal 20 is close to the shaft portion 72 of the link portion 70, the pedestal-side connection 22 of the pedestal 20 and the link-side connection portion 71 of the link portion 70 are not in contact or connected.

When the lifting operation of the table potion 11 by the lifting unit 30 is completed, that is, when the pedestal 20 is far from the shaft portion 72 of the link portion 70, the pedestal side-connection 22 of the pedestal 20 and the link-side connection portion 71 of the link portion 70 are in contact, the pedestal 20 and the link portion 70 are connected and vertical expansion and contraction of the telescopic arm 81 by the pedestal 20 enables the telescopic arm 81 to extend and retract vertically.

### In a Case of Underfloor Storage Unit

The use of the lift table 1 for underfloor storage unit 90 is explained in accordance with FIGS. 2A and 2B.

The underfloor storage unit 90 includes a cargo unit 91, a lid 92, and a lift table 1. The underfloor storage unit 90 is placed in an area surrounded by a pillar 95 and a floor 94 of an ordinary house.

First, lift table 1 is placed, and then the cargo unit 91 and the lid 92 are placed on top of the lift table 1.

Since a height of the underfloor portion is limited, a thickness of the lift table 1 should be as low as possible (FIG. 2A). Therefore, it is suitable if, at the lowest position, only the thickness of the base unit 10 and the table unit 11 can be used.

When using X-arms, it is suitable if the arms are parallel to each other at the lowest position.

To lift the arm, the telescopic arm 81 is lifted to a certain height by the lifting unit 30, and then the telescopic arm 81 is lifted by the link portion 70.

Since the space available for installation is limited, it is suitable if the top view size of lift table 1 is about the same as the size of the cargo unit 91.

By lifting the telescopic arm 81 to the uppermost position, the cargo unit 91 is moved to a position higher than the floor 94 (FIG. 2B).

When used in underfloor storage, the size of the lift table 1 must be extremely compact. Also, as mentioned above, it must be thin when lowered to the floor. Some large low-floor lift tables are equipped with an inclined portion or the like on the arm and lift the arm using the inclined portion and a cam when lowered. However, in many cases, the position of the inclined portion, etc. on the arm is determined by the driving force and other factors in the design.

Compact lifting equipment often has a restricted layout and often cannot employ the same structure as large, low-floor lifting equipment.

In contrast, in this embodiment, the inclined portion is placed on the bottom of the table, which allows for a greater degree of freedom in design.

### Regarding a Lifting Process

The process of the lifting table unit 11 is described along with FIG. 3A to FIG. 4C. FIGS. 3A to 3C are side cross-sectional views of the lift table 1, generally cut at the position of the first inclined portion 33, with some cut positions changed for illustrative purposes. FIGS. 4A to 4C are top views of the lift table 1, showing only the first inclined portion 33 at the bottom of the table unit 11, except for the table unit 11 as a whole. In FIGS. 4A to 4C, the guide rail 84 is omitted.

FIG. 3A and FIG. 4A show the case at the lowest position. The telescopic arm 81 is folded until the first lift arm 82 and the second lift arm 83 are parallel. To lift the table unit 11, the pedestal 20 is moved, in the right direction on the paper.

For lifting unit 30, the cylindrical portion 32 of the cam portion 31 is not attached to the inclined surface 34 of the first inclined portion 33.

The pedestal side-connection 22 of the pedestal 20 and the link-side connection portion 71 of the link portion 70 are separated and not connected.

FIG. 3B and FIG. 4B show the point in time when table unit 11 is lifted by the operation of lifting unit 30.

The pedestal 20 is moved to the right by the drive unit 12. In detail, hydraulic pressure in cylinder 13 of the drive unit 12 causes piston 14 to move in the right direction on the paper, and the pedestal 20, which is connected via the tow portion 23, moves in the same right direction as the piston 14.

When the pedestal 20 moves, the cylindrical portion 32 of the cam portion 31 attaches to and generates an upward force against the inclined surface 34 of the first inclined portion 33. The force on the first inclined portion 33 causes the table unit 11 to rise.

In FIG. 3B, the elevation by lifting unit 30 is complete.

The horizontally movable end of the second lift arm 83 of the telescopic arm 81 moves horizontally along the table unit 11 by means of the guide rail 84. The horizontally movable end of the first lift arm 82 moves horizontally along the base unit 10 by means of the guide rail 84.

Accordingly, the upper ends of the first lift arm 82 and the second lift arm 83 will rise, dragged by the rise of table unit 11. Accordingly, the first lift arm 82 and the second lift arm 83 will have some angles. The first lift arm 82 itself can then be moved and the telescopic arm 81 can be lifted, just like a normal X-arm.

The pedestal-side connection 22 of the pedestal 20 and the link-side connection portion 71 of the link portion 70 are in contact, and the end of the first lift arm 82 can be moved through the link portion 70 according to the movement of the pedestal 20.

FIG. 3C and FIG. 4C show the end of the first lift arm 82 moving in the right direction on the paper in conjunction with the pedestal 20 and the link portion 70, causing the telescopic arm 81 and the table unit 11 to rise.

A force of the piston 14 of the drive unit 12 moves the pedestal 20 to the right. Since the pedestal-side connection 22 of the pedestal 20 is connected to the link-side connection portion 71 of the link portion 70, the shaft of the first lift arm 82 connected to the shaft portion 72 of the link portion 70 moves as well. The mutual angles of the telescopic arms 81 increase, and the table unit 11 rises to the uppermost position.

### Regarding a Characteristics

A graph of the relationship between table height and piston load in this embodiment is shown in FIG. 15A. The lowest table position is when the table is at its lowest height and the highest position is when the table is at its highest height.

The dotted line shows the characteristics when only a conventional X-arm is used.

From the lowest table height to a certain extent, the table is pushed up by a cam structure, so it rises with a constant load.

From a part where the lift is completed by the cam structure, the lift table is lifted by the X-arm as similar as conventional method.

With the conventional method, the load is too large near the lowest position, making it difficult to the lift table unit 11, but by using the cam structure, table unit 11 can be lifted with a lower overall driving force.

### Modifications of the Embodiment 1

Modifications of the lifting unit 30 are described along with FIGS. 6A to 6D.

The Embodiment 1 describes a form in which the first inclined portion 33 is fixed to the bottom of the table unit 11 and the cam portion 31 is fixed to the pedestal 20 (FIG. 6A).

Other possible shape is one in which the first inclined portion 33 is fixed to the base unit 10, the table unit 11 has the pedestal 20, and the cam portion 31 is fixed to the pedestal 20 (FIG. 6B). In this structure, the base unit 10 side is applied the normal X-arm structure and the table unit 11 side has the moving structure. This structure is suitable for cases where the base unit 10 is difficult to remove, such as under-floor storage, because the drive unit, etc. is not on the base unit 10 side but on the table unit 11 side, so when performing a maintenance of the lift table, it is only necessary to check and/or replace the table part 11.

FIG. 6C is the case where the cam portion 31 is fixed to the table unit 11 and the first inclined portion 33 is fixed to the pedestal 20. In this case, the first inclined portion 33 is the driver node and the cam portion 31 is the follower node.

This structure is suitable for cases where table unit 11 is part of the cargo unit 91, since there is no inclined surface or other special shape on the table unit 11 side, and there are no driving parts.

FIG. 6D shows the above shape inverted.

In summary, in each embodiment, the table unit 11 is lifted and lowered depending on the relative position between the inclined surface 34 of the first inclined portion 33 and the cam portion 11. The first inclined portion 33 or the cam portion 31 is placed at the bottom of the table unit 11. The cam portion 31 or the first inclined portion 33 corresponding to the pedestal 20 is placed. The table unit 11 is lifted and lowered by moving the pedestal 20 in the horizontal direction and changing the relative position between the inclined surface 34 of the first inclined portion 33 and the cam portion 31.

Thus, according to the Embodiment 1, the structure of the lift table is not larger than the cargo area from the top view, and it has a low table structure, making it easy to install as a housing facility and allowing for greater flexibility when designing the lifting structure.

### Embodiment 2

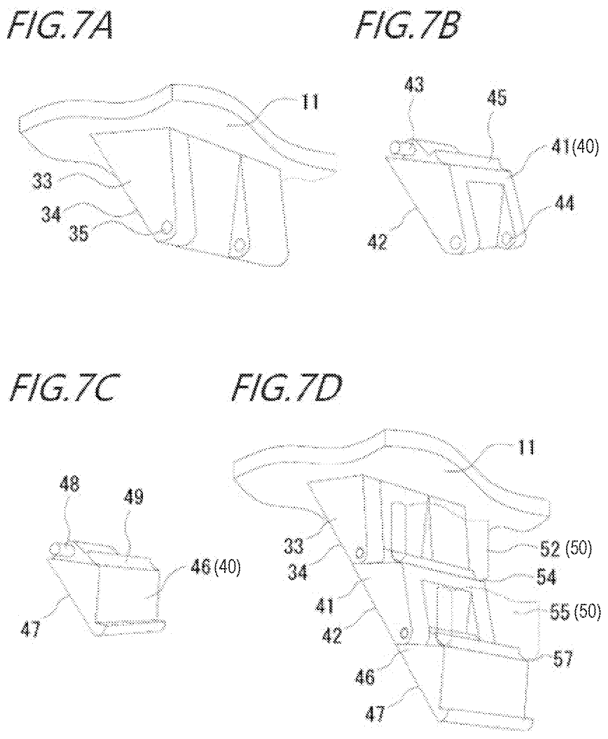

Other embodiments will be described using FIG. 7A to 11B. Parts similar to Embodiment 1 are omitted.

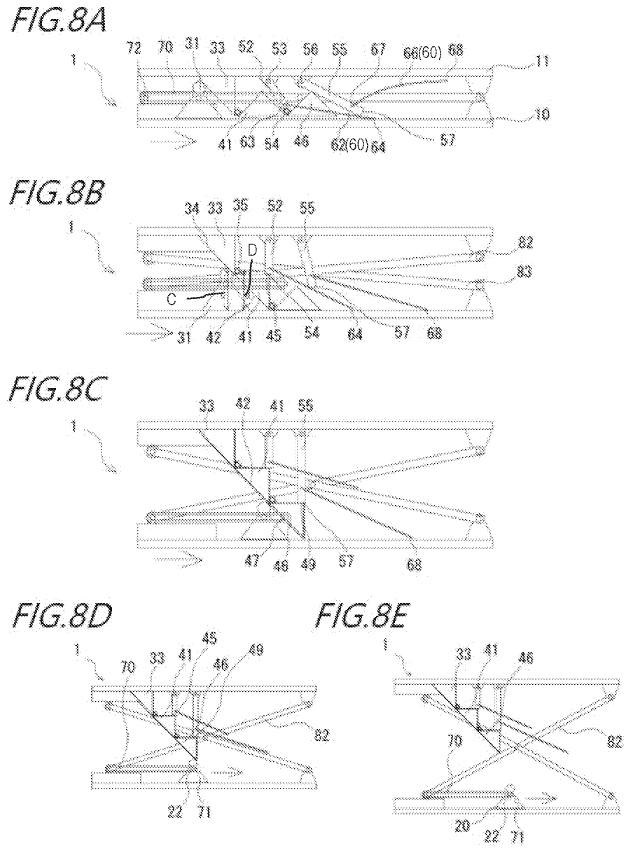

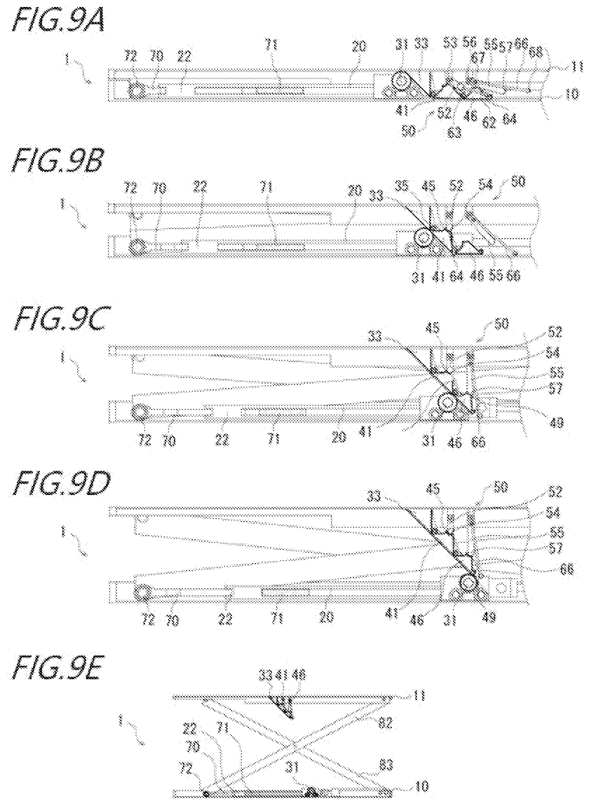

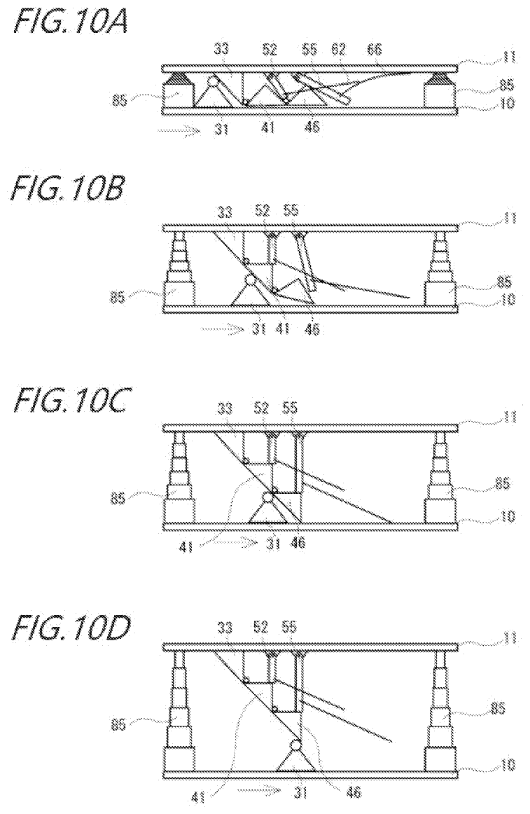

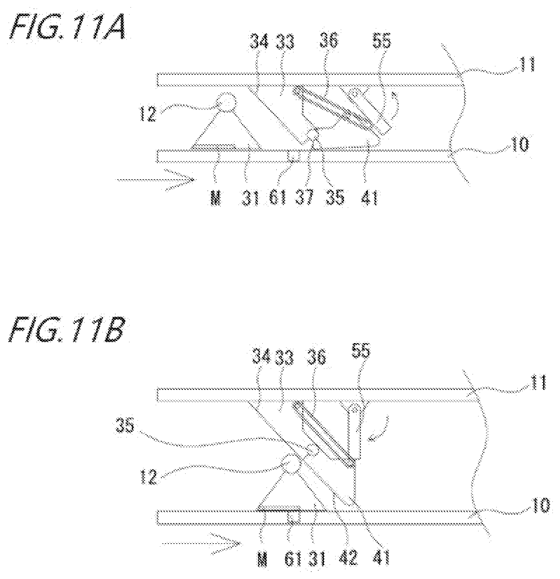

FIGS. 7A to 7D show other embodiments of the inclined portion of the lift table according to the invention, FIG. 7A shows the shape of the first inclined portion 33 partially deformed, FIG. 7B shows the shape of the second inclined portion (A) 41, and FIG. 7C shows a shape of the second inclined portion (B) 46. FIG. 8A to 11B show other embodiments of the lift table, with FIGS. 8A to 8E show side schematic diagrams of the process of lifting the table unit 11, FIGS. 9A to 9E show cross-sectional diagrams of the process of lifting the table unit 11, FIGS. 10A to 10D show side schematic diagrams of the case where a cylinder is used as the regulating part, and FIGS. 11A and 11B show the case where the support is controlled electrically.

### Regarding Problems

According to the structure of Embodiment 1, it can be lifted and lowered from a very low table position. However, in the case of lifting in a one step inclined portion, the angle of the X-arm may not be sufficient to drive the arm sufficiently. In addition, there were also difficulties with the combined method of elevation by the drive unit and elevation by the movement of the axis of the arm when a constant lifting speed is desired.

Therefore, a cam structure was required to lift it higher.

In addition to the configuration of Embodiment 1, the lift table 1 of Embodiment 2 has, as the lifting unit 30, a second inclined portion 40, a support portion 50 that is rotatably connected to the bottom of the table unit 11, and supports the second inclined portion 40, and a rotation control unit 60 that controls the rotation of the support portion 50. The shape of the first inclined portion 33 is slightly different. Other structures are equivalent to Embodiment 1.

The second inclined portion 40 is an extension of the inclined surface in the cam structure.

The second inclined portion 40 can be one or more than one. The second inclined portion 40 extends the inclined surface in a way that connects to the lower end of the first inclined portion 33. The shape of the first inclined portion 33 is accordingly modified.

The guide rail 84 is omitted for FIG. 8A to FIG. 9E, as it has the same shape and effect as in Embodiment 1.

### Regarding the Inclined Portion

The first inclined portion 33 and the second inclined portion 40 are described along with FIGS. 7A to 7D. FIG. 7A shows the first inclined portion 33. The first inclined portion 33 is fixed to the bottom of the table unit 11 in a same way as in Embodiment 1, but two shaft holes 35 are drilled in the bottom edge. The space between the two shaft holes 35 is recessed so that the shaft of the second inclined portion 40, which is another component, can be inserted.

FIG. 7B shows the second inclined portion 40, which is the second inclined portion (A) 41, the member of the second inclined portion 40 which is closer to the first inclined portion 33. The second inclined portion (A) 41 has an inclined surface 42 similar to the first inclined portion 33. An upper part of the second inclined portion (A) 41 has a shaft 43 that connects to the first inclined portion 33, and a lower part has a shaft hole 44 that connects to the other second inclined portion 40. At the top of the second inclined potion (A) 41, on the opposite side of the inclined surface 42, there is a contact portion 45. The contact portion 45 is contacted by the tip portion 54 of the support portion (A) 52 and regulates a rotation of the second inclined portion (A) 41 in the upward direction.

When the first inclined portion 33 and the second inclined portion (A) 41 are at a predetermined angle, in other words, when the tip of the support portion (A) 52 supports the contact portion 45 of the second inclined portion (A) 41 in the vertical direction, the rotation of the second inclined portion (A) 41 is restricted by the support portion (A) 52 and the inclined surfaces 34 and 42 forms same plane.

FIG. 7C is the second inclined portion 40, the second inclined portion (B) 46, which is the more distant member of the plurality of the second inclined portion 40, relative to the first inclined portion 33.

The second inclined portion (B) 46 has an inclined surface 47 similar to the first inclined portion 33. At the top of the inclined surface 47, there is a shaft 48 that connects to the second inclined portion (A) 41. At the top of the second inclined portion (B) 46, opposite the inclined surface 47, there is a contact portion 49. The contact portion 49 is contacted by the tip portion 57 of the support portion (B) 55 and regulates the rotation of the second inclined portion (B) 46 in the upward direction.

The inclined surface 34, the inclined surface 42 and the inclined surface 47 form a same surface when the first inclined portion 33, the second inclined portion (A) 41 and the second inclined portion (B) 46 are at a given angle, in other words, when the rotation of the second inclined portion (A) 41 is regulated by the support portion (A) 52 and the rotation of the second inclined portion (B) 46 is regulated by the support portion (B) 55, when the rotation of the second inclined portion (B) 46 is regulated by the support portion (B) 55.

There is a plurality of relationships between the two second inclined portions 40, and adjacent each other. Each of the second inclined portions has a shaft hole parallel to the end edge at the lower end edge of the inclined surface of one of the second inclined portion. A shaft parallel to the end edge at the end edge of the inclined surface of the other of the second inclined portion. When the contact portion of the second inclined portion is supported in the vertical direction at the tip of the support it can be said that the inclined surfaces of all second inclined portions are composed of the same flush surface.

FIG. 7D shows the oblique view in a case where inclined surfaces of the first inclined portion 33, the second inclined portion (A) 41, and the second inclined portion (B) 46 are in a same plane.

The lower-end edge of the inclined surface 34 of the first inclined portion 33 and the upper-end edge of the inclined surface 42 of the second inclined portion (A) 41 are connected by a parallel shaft structure that is rotatable.

Since the second inclined portion (A) 41 is supported by the support portion (A) 52 and the second inclined portion (B) 46 is supported by the support portion (B) 55, the inclined surface will not collapse when there is a force from the cam portion 31.

### Regarding the Support Portion

The support portion 50 ensures that the inclined surface of the second inclined portion 40 forms a same plane as the inclined surface 34 of the first inclined portion 33 and that the second inclined portion 40 does not tilt in response to the force from the cam portion 31.

The case with two second inclined portions 40 is described below.

The two second inclined portions 40 includes a second inclined portion (A) 41 and a second inclined portion (B) 46. There are two corresponding support portions 50, includes a support portion (A) 52 and a support portion (B) 55. The support portion (A) 52 and the support portion(B) 55 are fixed to the bottom of the table unit 11 by means of a shaft 53 and a shaft 56 for pivoting. The support portion (A) 52 and the support portion(B) 55 are rotated around the shafts 53 and 56. The support portion 50 has a structure in which the tip of the support portion 50 faces in a vertical direction by its own weight when there is no force from other sources.

When the inclined surface of the second inclined portion 40 is in a same plane with the inclined surface 34 of the first inclined portion 33, a tip portion 54 of the support portion (A) 52 and a tip portion 57 of the support portion(B) 55 are brought into contact with the contact portion 45 and the contact portion 49, respectively. The contact portions 45 and 49 are in contact with the support portion (A) 52 and the support portion(B) 55 when they are oriented in the vertical direction.

When the cam portion 31 moves on the inclined surface 42 and the inclined surface 47, the force from the cam portion 31 prevents the second inclined position (A) 41 and the second inclined portion (B) 46 from shifting those position.

The tip portions 54 and 57 of the support portion are pivoted away from the first inclined portion 33, rather than in the longitudinal direction of the support portion 50, when the corresponding the second inclined portion (A) 41 and the second inclined portion (B) 46, respectively, are not in use at low table position. The pivoting prevents the support portion 50 from getting in the way when the table unit 11 is lowered when the table unit 11 is lowered.

The rotation is performed by the rotation control unit 60.

The support portion 50 is equipped with a rotation control unit 60 so that the support portion 50 can be smoothly pivoted when not in use.

### Regarding the Rotation Control Unit)

The rotation control unit 60 is used to make the tip of the support portion 50 faces in a vertical direction when the support portion 50 is in use and to rotate it away from the first inclined portion 33 when not in use.

The rotation control unit 60 is rod-shaped, a base part thereof is connected to the support portion, and the tip part thereof is in the direction away from the first inclined portion, rather than in the longitudinal direction of the support portion. The rotation control unit 60 has elasticity, and the tip thereof, if necessary, contacts the base unit 10 and attaches to the support portion 50.

The rotation control unit 60 is light enough compared to the support portion 50 that the weight of the support portion 50 does not interfere with the vertical orientation of the support portion 50.

The rotation control unit 60 has a rotation control portion (A) 62 and a rotation control portion (B) 66 for the support portion (A) 52 and the support portion (B) 55. The base ends of the rotation control portion (A) 62 and the rotation control portion (B) 66 are connected to the support portion (A) 52 and the support portion (B) 55, respectively. And the tip ends of the rotation control portion (A) 62 and the rotation control portion (B) are in the direction away from the first inclined portion than in the longitudinal direction of the support portion.

At the lowest table position, the second inclined portion (A) 41 and the second inclined portion (B) 46 are folded, and when the inclined surface is used, they are turned and supported by the support portion 50.

The rotation control portion (A) 62 controls the support portion (A) 52 by making the support portion (A) 52 slanted when the second inclined portion (A) 41 is not in use, and just before and during use, making the support portion (A) 52 face vertically, ready for and in contact with the contact support portion 45.

When transitioning from a state of use to a state of not in use, the support portion (A) 52 is slanted when the state of not in use is reached.

When lifting the table unit 11, the rotation control portion 60 rotates the support portion 50 from the slanted state to the vertical direction just before the corresponding second inclined portion 40 is in use.

When lowering the table unit 11, the rotation control portion 60 rotates the support portion 50 from a vertical to an oblique state immediately after the corresponding second inclined portion 40 is unused.

In both cases, the timing of the rotation is when the cam portion 31 is near the below end of the inclined surface above the target inclined portion.

As an example of the definition of the position of the cam portion 31, the position of the cam portion is a height from the base unit 10 to a contact area between the cam portion 31 and the inclined surface 34 of the first inclined portion 33 (hereinafter also called the height C of the contact surface.) (FIG. 8B)

The definition of the location near the bottom of the inclined portion can be a height from the base unit 10 to the center of the axis of the shaft, which is shaft hole 35 near the bottom of the first inclined portion 33 (hereinafter also referred to as the height D near the bottom of the inclined surface 34) (FIG. 8B)

Another way to define it is to define it as the height from the base to a position closer to the bottom than halfway between the top and bottom of the inclined surface of the first inclined portion 33.

The turning operation of the rotation control portion 60 is performed with the tip of the rotation control portion 60 in contact with the base unit 10 or not.

At the time of ascent, the rotation control portion 60, which is initially placed at an angle to support portion 50, is in contact with the base unit 10, so it receives a force from the base unit 10 and the support portion 50 is rotated at an angle.

As the ascent continues, the support portion 50 gradually rotates in a vertical direction, and when the shaft of the support portion 50 reaches a certain height, the tip of the rotation control portion 60 no longer contacts the base unit 10, and the support portion 50 faces in a vertical direction by its own weight.

During descent, the tip of the rotation control portion 60 does not initially contact the base unit 10, so the support portion 50 faces in a vertical direction due to its own weight. After descending to a certain height, the tip of the rotation control portion 60 contacts the base unit 10. Since the tip of the rotation control portion 60 is further from the first inclined portion 33 than the longitudinal direction of the support portion 50, the tip of the rotation control portion 60 slides on the base unit 10 and forces the support portion 50 to rotate in a direction away from the first inclined portion 33. As a result, the support portion 50 is tilted at an angle.

Therefore, it is suitable if the structure is such that the tip of the rotation control portion 60 makes contact without any force when the height C of the contact surface is equal to height D near the bottom of the inclined surface 34.

### Regarding the Lifting Operation

The process of lifting table unit 11 is described along with FIG. 8A to FIG. 9E. FIGS. 8A to 8E are side schematic views of the lift table 1. The dimensions and shape have been changed as necessary for the sake of explanation.

FIGS. 9A to 9E show side cross-sectional views of the lift table 1. To make it easier to see, some of the cross-sectional positions have been changed.

FIG. 8A and FIG. 9A show the case where lift table 1 is at its lowest table position.

The first and second lift arms 82 and 83 are folded to be parallel.

The second inclined portion (A) 41 and the second inclined portion (B) 46 fit between the table unit 11 and the base unit 10, with the inclined surfaces 42 and 47 parallel to the base unit 10.

The support portion (A) 52 and the support portion (B) 55 are fixed at one end to the table unit 11 by shafts 53 and 56, and fit between the table unit 11 and the base unit 10 with the tip portions 54 and 57 pivoted away from the first inclined portion 33.

The support portion (A) 52 and the support portion(B) 55 have a rotation control portion (A) 62 and a rotation control portion (B) 66 for rotation as appropriate.

The rotation control portion (A) 62 and the rotation control portion (B) 66 are fixed to the side of the support portion (A) 52 and the support portion (B) 55 by the base unit end 63 and the base unit end 67 so that the tip portion 64 and the tip portion 68 face downward at an angle to the longitudinal direction of the support portion (A) 52 and the support portion (B) 55, respectively.

The tip portion 64 of the rotation control portion (A) 62 contacts the base unit 10, receives a force, and rotates the support portion (A) 52 in the direction away from the first inclined portion 33.

The cam portion 31 on the pedestal 20 moves to the right on the paper to attach against the first inclined portion 33.

The pedestal 20 and the first lift arm 82 are connected via the link portion 70.

FIG. 8B and FIG. 9B show the table unit 11 being lifted by the cam portion 31 contacting the first inclined portion 33.

Table unit 11 is lifted, the cam portion 31 is near the bottom of the first inclined portion 33, and the height C of the contact surface and the height D near the bottom of the inclined surface 34 are nearly identical. The tip portion 64 of the rotation control portion (A) 62 is in slight contact with the base unit 10, and the tip portion 54 of the support portion (A) 52 is pointing vertically, due to its own weight.

To summarize the relationship between the height C of the contact surface, the height D near the bottom of the inclined surface 34, and the rotation control portion, when the height from the base unit 10 to the bottom of the inclined surface 34 is less than the height from the base unit 10 to the contact portion between the cam portion and the inclined surface of the first inclined portion, the tip of the rotation control portion contacts the top of the base. And the rotation control portion biases a force so that the tip rotates in the direction away from the first inclined portion.

When the height from the base unit 10 to the bottom of the inclined surface 34 is greater than the height from the base unit 10 to the contact area between the cam portion and the inclined surface of the first inclined portion, the tip of the support portion faces in a vertical direction due to its own weight.

The second inclined portion (B) 46 is still in a state with the inclined surface 47 is parallel to the base unit 10. The support portion(B) 55 for the inclined surface 47 is rotated by the rotation control portion (B) 66 in the direction away from the first inclined portion 33 and is in an oblique state.

The second inclined portion (A) 41 is turned in the direction of the cam portion 31 in response to the rise of the table unit 11, being pulled by the connected first inclined portion 33.

There is a gap between the contact portion 45 of the second inclined portion (A) 41 and the tip portion 54 of the support portion (A) 52.

The cam portion 31 then moves from the inclined surface 34 of the first inclined portion 33 to the inclined surface 42 of the second inclined portion (A) 41, thereby applying a force against the inclined surface 42, and the contact portion 45 of the second inclined portion (A) 41 and the tip portion 54 of the support portion (A) 52 contact each other.

In this case, the inclined surfaces 34 and 42 are the same inclined surface, and the inclined surface of the cam structure is twice as large as in the case of only the first inclined portion 33, allowing the table unit 11 to lift more.

FIG. 8C and FIG. 9C show it lifting further, with the contact surface of the cam portion 31 near the lower end of the second inclined portion (A) 41.

The second inclined portion (B) 46 is the one that corresponds to the second inclined portion (A) 41 in FIG. 8B.

The tip portion 68 of the rotation control portion (B) 66 is in slight contact with the base unit 10, and the tip portion 57 of the support portion (B) 55 is pointing vertically, due to its own weight.

The second inclined portion (B) 46 turns in the direction of the cam portion 31, pulled by the connected second inclined portion (A) 41, as the table unit 11 rises.

There is a gap between the contact support 49 of the second inclined portion (B) 46 and the tip portion 57 of the support portion (B) 55.

The cam portion 31 then moves from the inclined surface 42 of the second inclined portion (A) 41 to the inclined surface 47 of the second inclined portion (B) 46, thereby applying a force against the inclined surface 47, and the contact portion 49 of the second inclined portion (B) 46 and the tip portion 57 of the support portion (B) 55 contact each other.

In this case, the inclined surfaces 34, 42, and 47 are the same inclined surface, and the inclined surface of the cam structure is three times larger than in the case of only the first inclined portion 33, allowing the table unit 11 to lift more.

FIG. 8D and FIG. 9D show the cam portion 31 completing its movement on the three inclined planes.

The pedestal-side connection 22 of the pedestal 20 and the link-side connection portion 71 of the link portion 70 are connected without gaps, and the shafts of the pedestal 20, the link portion 70, and the first lift arm 82 are integrated.

The ascent up to this point was performed by the cam structure with the cam portion 31, the first inclined portion 33, the second inclined portion (A) 41, and the second inclined portion (B) 46. After this, the table unit 11 is lifted by the pedestal 20 moving the axis of the first lift arm 82 via the link portion 70.

FIG. 8E and FIG. 9E show the case when the table unit 11 is lifted to the uppermost position. The operation is the same as the arm drive by the normal X-arm.

Thus, according to this embodiment, the cam structure can significantly increase the amount of the table unit 11 elevation, and even when the driving force is small and the arm cannot be driven sufficiently at a low table, table unit 11 can be sufficiently elevated and the arm can be driven when the driving load on the arm is reduced.

In addition, according to this embodiment, the cam structure provides a wider range of constant-speed ascent, which improves the appearance of the elevation quality.

### Regarding the Characteristics

A graph of the relationship between the table height and the piston load in Embodiment 2 is shown in FIG. 15B. The lowest table position is when the table is at its lowest height and the highest position is when the table is at its highest height.

The dotted line shows the characteristics when only the conventional X-arm is used.

The table height rises from the lowest position to some extent with a constant load because the cam structure pushes the table up. Since the amount of rise by the cam structure is greater than in Embodiment 1, the section where the load is constant is longer than in FIG. 15A.

The increase in load after the cam structure is completed is smaller than in FIG. 15A.

Thus, by using multiple inclined potions, the drive unit with a small driving force can be used as a whole, which is also suitable in terms of consumption reduction.

### Regarding Modifications, Using a Cylinder Structure

An embodiment of not using an X-arm as the regulatory portion 80 is illustrated along with FIGS. 10A to 10D.

Although a cam structure and X-arm can be used to obtain a large amount of lift, a cylinder structure 85 can be used in place of the X-arm if the amount of lift required is only the amount of lift due to the multiple inclined potions.

The cylinder structure 85 consists of a number of cylinders of different thicknesses stacked concentrically, and by changing the amount of overlap between the cylinders, the overall length can be changed to allow for expansion and contraction.

The cylinder structure 85 itself has no force to lift the table, and it regulates the horizontal movement of table unit 11 while extending upward along the rise of table unit 11 by using cylinder structure 85, the structure of the lift table 1 can be simplified.

FIG. 10A is at the lowest floor, FIG. 10B, FIG. 10C, and in turn, table unit 11 is lifted using the first inclined portion 33, the second inclined portion (A) 41, and the second inclined portion (B) 46.

In FIG. 10D, the lifting of the table unit 11 by the cam structure is completed, and this position is the uppermost position of the lift table 1 itself.

By using this structure, the table unit 11 can always be lifted at a constant speed. Also, by adjusting the amount of inclination of the cam structure, it is possible to lift and lower a large load.

### Regarding Modifications, Using an Electric

An embodiment in which the rotation control portion 60 is operated by electricity is described along with FIGS. 11A and 11B.

In FIG. 8A, etc., the case where the rotation control portion 60 is a bar described, but it can also be controlled by a position sensor (hereinafter referred to as a pedestal position sensor), a rotation drive unit, and a control unit.

The rotation control portion 60 includes a rotary drive unit 51 and a position sensor 61.

When the support portion 50 is in use, the support portion 50 is oriented vertically, and when not in use, the support portion 50 is rotated diagonally so that the second inclined portion 40 does not strike the base unit 10, etc., as in the bar-shaped case.

The rotary drive unit 51 is a drive portion that is located on the shaft portion of the support portion 50 and can rotate to any angle around the shaft portion. The angle can be specified using an encoder, or a stepping motor can be used to rotate to a predetermined angle.

The position sensor 61 is used to detect the position of the pedestal 20 and the cam portion 31. For example, a marker M attached to pedestal 20 can be detected by a sensor located on the base unit 10.

The control unit, not shown in the figure, controls the rotary drive unit 51 to the appropriate angle according to the information from the position sensor 61.

In FIGS. 11A and 11B, the rotation restriction portion 37 restricts the rotation of the second inclined portion 40 to some extent. Even before the second inclined portion 40 is supported by the support portion 50, the rotation restriction portion 37 prevents the surfaces of the inclined surface 34 and the inclined surface 42 from shifting significantly. This structure prevents the second inclined portion (A) 41 from moving significantly when the cam portion 31 moves from the inclined surface 34 to the inclined surface 42.

The auxiliary portion 36 regulates the distance between the axes on the top of the first inclined portion 33 and the top of the second inclined portion (A) 41 to within a certain distance. Similar to the rotation control portion 60, the auxiliary portion 36 restricts the rotation of the second inclined portion 40 to some extent.

The state in which the position sensor 61 does not detect the marker is the state in which the second inclined portion (A) 41 is not in use and the support portion (A) 52 should be slanted.

The state in which the position sensor 61 detects the marker is the state in which the second inclined portion (A) 41 is in use or being prepared for use, and the support portion (A) 52 should be oriented vertically.

FIG. 11A shows that position sensor 61 is not detecting the marker M on pedestal 20.

Therefore, since the second inclined portion 40 is not in use, the rotary drive unit 51 is controlled to set the longitudinal angle of the support portion 50 away from the first inclined portion 33.

In other words, when the pedestal position sensor detects that pedestal 20 is at a position where the height C from the base unit 10 to the lower end of the inclined surface 34 of the first inclined portion 33 is less than the height D from the base unit 10 to the contact portion between the cam portion 31 and the inclined surface 34 of the first inclined portion 33, the rotation control portion 62 rotates the tip of the support portion 52 in a direction in which the tip of the support portion 52 moves away from the first inclined portion 33.

FIG. 11B shows the cam portion 31 and the pedestal 20 moving, with the cam portion 31 coming near the lower end of the inclined surface 34.

The position sensor 61 is in the state of detecting marker M on the pedestal 20. Therefore, since the second inclined portion 40 is in use, the rotary drive unit 51 is controlled to orient the longitudinal direction of the support portion 50 in the vertical direction.

In other words, when the pedestal position sensor detects that pedestal 20 is at a position where the height C from the base unit 10 to near the bottom of the inclined surface 34 of the first inclined portion 33 is greater than the height D from the base unit 10 to the contact portion between the cam portion 31 and the inclined surface 34 of the first inclined portion 33, the rotation control portion (A) 62 rotates the end of the support portion (A) 52 tip is rotated in the vertical direction.

Similarly, during descent, this action causes the support to rotate, depending on what is detected by the position sensor 61.

Thus, by using a position sensor and drive unit, the lifting and lowering operation can be performed more accurately and smoothly.

### Embodiment 3

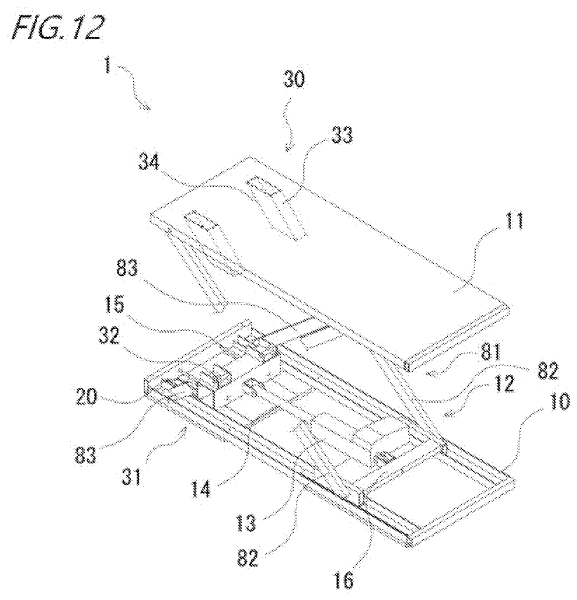

Other embodiments will be described using FIGS. 12 to 14C. Parts similar to Embodiment 1 are omitted.

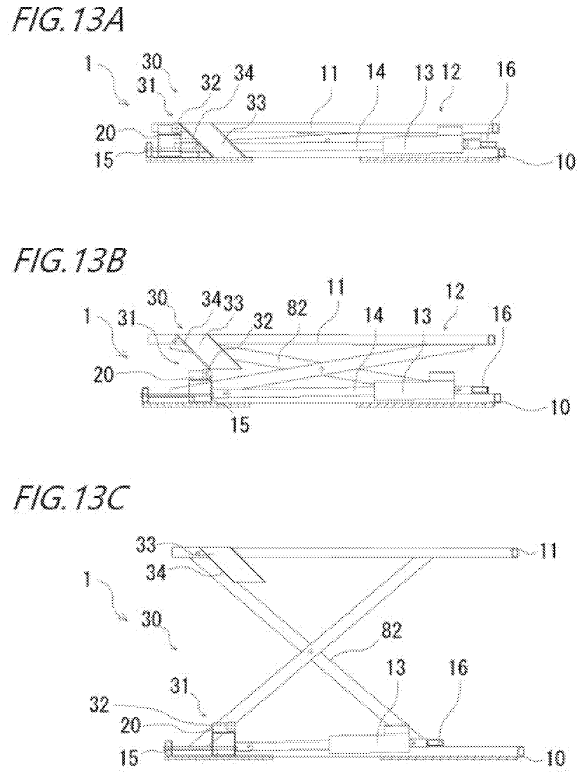

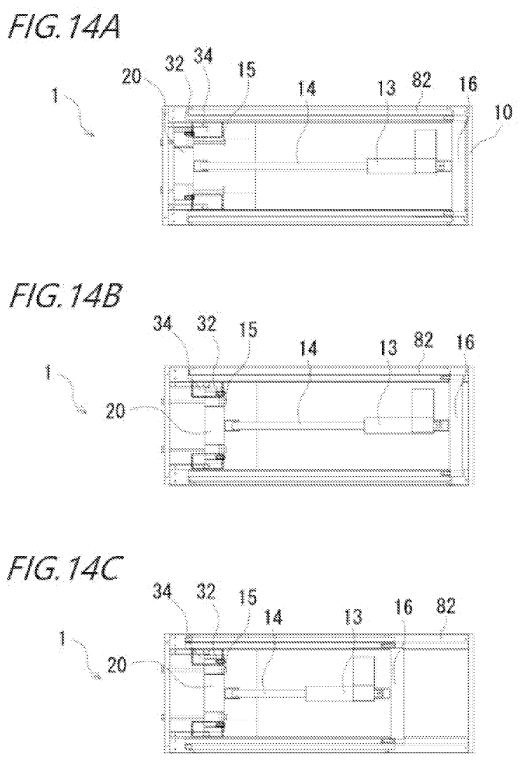

FIG. 12 is an overall view of another embodiment of the lift table for the present invention, with part of the lift arm not drawn to make the drive unit and other parts easier to see. FIGS. 13A to 13C are cross-sectional views of another embodiment of the lift table according to the present invention, FIG. 13A shows the lowest position of the lift table, FIG. 13B shows the table lifted by the cam structure of the lift table, and FIG. 13C shows the highest position of the lift table. FIGS. 14A to 14C top views of another embodiment of the lift table, excluding the table, FIG. 14A shows the lowest position of the lift table, FIG. 14B shows the table lifted by the cam structure of the lift table, and FIG. 14C shows the highest position of the lift table.

### Regarding the Problem

According to the structure of Embodiment 1, it can be made possible to lift and lower from a very low table position. However, the X-arm structure of Embodiment 1 requires a link portion 70 and a guide rail 84 near the moving end of the first lift arm 82, and further structural simplification was required.

The lift table 1 in Embodiment 3 has no link portion 70, has a stopper portion 15, and has a different relationship between the drive unit 12 and the regulatory portion 80, compared to the structure of Embodiment 1. The other structures are almost the same as in Embodiment 1.

### Regarding the Drive Unit

The drive unit 12 is the part that generates the force to lift and lower the lift table 1 and moves the moving ends of the pedestal 20 and the first lift arm 82 in the horizontal direction.

One end of the drive unit 12 is connected to the moving end of the first lift arm 82 via the arm end retainer 16, and the other end of the drive unit 12 is connected to the pedestal 20. Since the arm end retainer 16 is fixed to the drive unit 12 and the moving end of the first lift arm 82, the drive portion 12 and the moving end of the first lift arm 82 move together.

Unlike Embodiment 1, one end of the drive unit 12 is not fixed to the base unit 10, but to the end of the first lift arm 82 via the arm end retainer 16.

The drive unit 12 moves the end of the first lift arm 82 to the pedestal 20 when the pedestal 20 is restricted by the stopper portion 15.

### Regarding the Stopper Portion

The stopper portion 15 regulates the horizontal movement of the pedestal 20.

Located between the drive unit 12 and the pedestal 20, when the table unit 11 is at its lowest position, the pedestal 20 and the stopper portion 15 are not in contact, and when the lifting movement of the table unit 11 by the lifting unit 30 is completed, the pedestal 20 and the stopper portion 15 are in contact, and the movement of the pedestal 20 is restricted by the stopper portion 15.

### Regarding the Regulatory Portion

In this embodiment, an X-arm type telescopic arm 81 is used, as in Embodiment 1. The basic operation is the same as in Embodiment 1.

The telescopic arm 81 is structured with a first lift arm 82 and a second lift arm 83 mutually rotatably connected between the base unit 10 and the table unit 11.

One end (moving end) of the first lift arm 82 is connected to the end of the drive 12 via the arm end retainer 16.

In Embodiment 1, the drive unit 12 moves the pedestal 20, and the pedestal 20 moves the end of the first lift arm 82 via the link portion 70, but in this embodiment, the drive unit 12 moves the moving end of the first lift arm 82 via the arm end retainer 16.

In Embodiment 1, the end of the first lift arm 82 (moving end) may generate a lifting force when the drive unit 12 lifts the table unit 11, and a guide rail 84 was necessary to control this. In this embodiment, however, the moving end of the first lift arm 82 is integrated with the drive unit 12, so it does not lift up, and guide rail 84 is not necessary.

This structure eliminates the need for the guide rail 84 and the link portion 70 near the moving end of the first lift arm 82, making it an extremely simple structure.

### Regarding the Lifting Process

The process of lifting table unit 11 is described along FIG. 13A to FIG. 14C. FIG. 13A is a side cross-sectional view of the lift table 1, cut generally at the position of the first inclined portion 33. FIGS. 14A to 14C are top views of the lift table 1, show only the first inclined surface 34 at the bottom of table unit 11, except for table unit 11 as a whole.

FIG. 13A and FIG. 14A show the case at the lowest position. The telescopic arm 81 is folded until the first lift arm 82 and the second lift arm 83 are almost parallel. To lift the table unit 11, the pedestal 20 is moved, in the right direction on the paper.

One end of the drive unit 12 is connected to the moving end of the first lift arm 82 via the arm end retainer 16. The other end of the drive unit 12 is connected to the pedestal 20.

To lift the table unit 11, the drive unit 12 is driven in a direction that shortens the distance between the drive unit 12 and the pedestal 20, in other words, it moves the pedestal 20 in the right direction on the paper.

One end of the drive unit 12 is connected to the first lift arm 82, so it exerts a force on the first lift arm 82 in the direction of pulling up the first lift arm 82, but because the angle between the first and second lift arms is small, the first lift arm 82 cannot be pulled up., All the force of the drive unit 12 moves in the direction of pulling the pedestal 20.

The cam portion 31 of the pedestal 20 contacted the inclined surface 34 of the first inclined portion 33, generating a force that pushes the table unit 11 up. This operation is the same as in Embodiment 1.

FIG. 13B and FIG. 14B show the point in time when table unit 11 is lifted by the

operation of the lifting unit 30.

The pedestal 20 is moved to the right on the paper surface by drive unit 12. In detail, hydraulic pressure in the cylinder 13 of the drive unit 12 moves the piston 14 in the right direction on the paper, and connected the pedestal 20 also moves in the right direction on the paper like the piston 14.

As similar to Embodiment 1, when the pedestal 20 is moved, the cylindrical portion 32 of the cam portion 31 is attached to and generates an upward force against the inclined surface 34 of the first inclined portion 33.

In FIG. 13B, the elevation by the lifting unit 30 is complete.

The lifting of table unit 11 by the lifting unit 30 causes the first lift arm 82 and the second lift arm 83 to have some angle.

The stopper portion 15 is located at the position of the pedestal 20 where the table unit 11 is pushed up by the lifting unit 30. Therefore, the pedestal 20 does not move to the right more than necessary, but on the contrary, the structure is such that the pedestal 20 moves the drive unit 12 to the left.

Since the drive unit 12 is connected to the moving end of the first lift arm 82, the force of the drive unit 12 moves the moving end of the first lift arm 82 to the left, increasing the angle between the first lift arm 82 and the second lift arm 83 and lifting the table unit 11.

FIG. 13C and FIG. 14C show the end of the first lift arm 82 moving in the left direction on the paper by the force of the drive unit 12 on the axis of the pedestal 20, which is regulated by the stopper portion, and the telescopic arm 81 and the table unit 11 lifting.

The telescopic arms 81 increase their angle to each other, and the table unit 11 rises to its uppermost position.

Thus, according to this embodiment, the guide rail that prevents the moving end of the lift arm from lifting unintentionally becomes unnecessary, and the structure can be simplified.

This structure is also suitable because it allows the inclined portion 33 and the pedestal 20 to be installed on the same side, making reinforcement easier.

Also, according to this embodiment, the upper guide of the guide rail 84 is unnecessary, and there is no displacement in the load direction of the moving end of the lift arm when lifting the table unit 11 with the inclined portion 33 and moving the lift arm to lift the table unit 11, making it suitable for less rattling (vibration and noise).

In addition, the structure can be simplified because the load-bearing parts, such as the lifting unit, the lift arm fixing portion, and the stopper portion, are gathered closer to the fixed end of the lift arm.

At least the following matters are described in the present specification. Although the constituent elements and the like corresponding to the embodiment described above are shown in parentheses, the present invention is not limited to this.

(1) A lifting mechanism for lift table including:
a base being bottom of the lifting mechanism;
a table;
a lifting unit configured to lift up and lower the table, the lifting unit being a cam structure, the lifting unit including a first inclined portion and a cam portion;
a pedestal;
a driver configured to move the pedestal in a horizontal direction; and
a regulator configured to restrict a movement of the table in the horizontal direction, wherein,
the table is lifted and lowered according to a relative position between an inclined surface of the first inclined portion and the cam portion,
the first inclined portion or the cam portion is located at a bottom of the table, and the corresponding cam or the inclined portion is located at the pedestal, and
the relative position between the inclined surface of the first inclined portion and the cam portion is changed by a movement of the pedestal in the horizontal direction.

(2) The lifting mechanism according to (1), wherein
the lifting unit includes a second inclined portion, a support portion rotatably connected to a bottom of the table and configured to support the second inclined portion, and a rotation control unit configured to control a rotation of the support portion,
the rotation control unit has a rod-like shape, the base of the rotation control unit is connected to the support portion, and the tip end of the rotation control unit locates in a direction away from the first inclined portion rather than in a longitudinal direction of the support portion,
a lower-end edge of the inclined surface of the first inclined portion and an upper-end edge of an inclined surface of the second inclined portion are connected by a parallel shaft structure to allow rotation,
the second inclined portion includes a contact portion against which a tip end of the support portion contacts,
when the tip end of the support portion supports the contact portion of the second inclined portion in a vertical direction, the inclined surface of the first inclined portion and the inclined surface of the second inclined portion form a same plane,
when a height from the base to near the bottom of the inclined surface of the first inclined portion is less than a height from the base to a contact area between the cam portion and the inclined surface of the first inclined portion, a tip end of the rotation control unit is in contact with a top surface of the base, and the rotation control unit is biased so that the tip end of the support portion rotates away from the first inclined portion,
when the height from the base to near the bottom of the inclined surface of the first inclined portion is greater than the height from the base to the contact area between the cam portion and the inclined surface of the first inclined portion, the tip end of the support portion faces vertically due to its own weight.

(3) The lifting mechanism according to (1), wherein
the lifting unit includes a second inclined portion, a support portion rotatably connected to a bottom of the table and configured to support the second inclined portion, and a rotation control unit configured to control a rotation of the support portion,
the rotation control unit includes a rotation drive unit and a pedestal position sensor,
a lower end edge of the inclined surface of the first inclined portion and an upper-end edge of the inclined surface of the second inclined portion are rotatably connected by an axis structure parallel to the upper-end edge,
the second inclined portion includes a contact portion against which a tip end of the support portion contacts,
when the tip of the support portion supports the contact portion of the second inclined portion in a vertical direction, the inclined surface of the first inclined portion and the inclined surface of the second inclined portion form a same plane,
when the pedestal position sensor detects that the pedestal is at a position where a height from the base to near the bottom of the inclined surface of the first inclined portion is less than a height from the base to the contact area between the cam portion and the inclined surface of the first inclined portion, the rotary drive unit rotates the support in a direction that the tip end of the support portion moves away from the first inclined portion,
when the pedestal position sensor detects that the pedestal is at a position where the height from the base to near the bottom of the inclined surface of the first inclined portion is greater than the height from the base to the contact area between the cam portion and the inclined surface of the first inclined potion, the rotary drive unit rotates the tip end of the support portion in a vertical direction.

(4) The lifting mechanism according to (2), wherein
the second inclined portion includes plural and adjacent each other, each of the second inclined portions includes: a shaft hole parallel to an edge on one of the edge of the inclined surface: and a shaft portion parallel to the edge on the another of the edge of the inclined surface,
when the contact part of the second inclined portion is supported in the vertical direction at the tip end of the support portion, the inclined surfaces of all the second inclined portions form a same plane.

(5) The lifting mechanism according to (3), wherein
the second inclined portion includes plural and adjacent each other, each of the second inclined portions includes: a shaft hole parallel to an edge on one of the edge of the inclined surface: and a shaft portion parallel to the edge on the another of the edge of the inclined surface, when the contact part of the second inclined portion is supported in the vertical direction at the tip end of the support portion, the inclined surfaces of all the second inclined portions form a same plane.

(6) The lifting mechanism according to any one of (1) to (5), wherein
the regulator is located at a bottom of the table.

(7) The lifting mechanism according to (6), further including:
a telescopic arm including first and second lift arms mutually rotatably connected between the base and the table, the telescopic arm being extendable by the pedestal; and
a link portion extending the telescopic arm up and down, wherein
one end of the first and second lift arms is moveable horizontally by a guide rail,
when the table is in a lowest position, the pedestal and the link portion are not connected,
when a lifting operation of the table by the lifting unit is completed, the pedestal is connected to the link portion.

(8) The lifting mechanism according to (6), further including:
a telescopic arm including first and second lift arms mutually rotatably connected between the base and the table, the telescopic arm being extendable by the pedestal; and
a link portion extending the telescopic arm up and down, wherein
one end of the first and second lift arms is moveable horizontally by a guide rail, the guide rail is located on the pedestal,
when the table is in a lowest position, an end of the guide rail is not connected to an end of the first lift arm,
when a lifting operation of the table by the lifting unit is completed, the end of the guide rail and the end of the first lift arm are connected.

(9) The lifting mechanism according to (6), further including:
a telescopic arm including first and second lift arms mutually rotatably connected between the base and the table, the telescopic arm being extendable vertically by an extension of the driver with respect to the pedestal, wherein
one end of the first and second lift arms is moveable horizontally by a guide rail,
one end of the driver is connected to one shaft of the first lift arm, and the pedestal is connected to the other end of the driver,
a stopper configured to restrict horizontal movement of the pedestal is provided between the driver and the pedestal,
when the table is in a lowest position, the pedestal and the stopper are not connected,
when a lifting operation of the table by the lifting unit is completed, the pedestal is contact with the stopper.

(10) The lifting mechanism according to (6), wherein
the regulator is a cylinder structure.

(11) The lifting mechanism according to (1), wherein
the driver is at least one of a hydraulic cylinder driven, a screw driven, a wire driven, and an air driven.

(12) The lifting mechanism according to (1), wherein
when the table is in a lowest position, the inclined portion is in contact with the base.

### INDUSTRIAL APPLICABILITY

The industrial applicability of a lifting mechanism for a lift table which is compact sized and low height type is understood to have great potential.

1. A lifting mechanism for lift table comprising:
a base being bottom of the lifting mechanism;
a table;
a lifting unit configured to lift up and lower the table, the lifting unit being a cam structure, the lifting unit including a first inclined portion and a cam portion;
a pedestal;
a driver configured to move the pedestal in a horizontal direction; and
a regulator configured to restrict a movement of the table in the horizontal direction, wherein
the table is lifted and lowered according to a relative position between an inclined surface of the first inclined portion and the cam portion,
the first inclined portion or the cam portion is located at a bottom of the table, and the corresponding cam or the inclined portion is located at the pedestal, and
the relative position between the inclined surface of the first inclined portion and the cam portion is changed by a movement of the pedestal in the horizontal direction.

2. The lifting mechanism according to claim 1, wherein
the lifting unit includes a second inclined portion, a support portion rotatably connected to a bottom of the table and configured to support the second inclined portion, and a rotation control unit configured to control a rotation of the support portion,
the rotation control unit has a rod-like shape, the base of the rotation control unit is connected to the support portion, and the tip end of the rotation control unit locates in a direction away from the first inclined portion rather than in a longitudinal direction of the support portion,
a lower-end edge of the inclined surface of the first inclined portion and an upper-end edge of an inclined surface of the second inclined portion are connected by a parallel shaft structure to allow rotation,
the second inclined portion includes a contact portion against which a tip end of the support portion contacts,
when the tip end of the support portion supports the contact portion of the second inclined portion in a vertical direction, the inclined surface of the first inclined portion and the inclined surface of the second inclined portion form a same plane,
when a height from the base to near the bottom of the inclined surface of the first inclined portion is less than a height from the base to a contact area between the cam portion and the inclined surface of the first inclined portion, a tip end of the rotation control unit is in contact with a top surface of the base, and the rotation control unit is biased so that the tip end of the support portion rotates away from the first inclined portion,
when the height from the base to near the bottom of the inclined surface of the first inclined portion is greater than the height from the base to the contact area between the cam portion and the inclined surface of the first inclined portion, the tip end of the support portion faces vertically due to its own weight.

3. The lifting mechanism according to claim 1, wherein
the lifting unit includes a second inclined portion, a support portion rotatably connected to a bottom of the table and configured to support the second inclined portion, and a rotation control unit configured to control a rotation of the support portion,
the rotation control unit includes a rotation drive unit and a pedestal position sensor,
a lower end edge of the inclined surface of the first inclined portion and an upper-end edge of the inclined surface of the second inclined portion are rotatably connected by an axis structure parallel to the upper-end edge,
the second inclined portion includes a contact portion against which a tip end of the support portion contacts,
when the tip of the support portion supports the contact portion of the second inclined portion in a vertical direction, the inclined surface of the first inclined portion and the inclined surface of the second inclined portion form a same plane,
when the pedestal position sensor detects that the pedestal is at a position where a height from the base to near the bottom of the inclined surface of the first inclined portion is less than a height from the base to the contact area between the cam portion and the inclined surface of the first inclined portion, the rotary drive unit rotates the support in a direction that the tip end of the support portion moves away from the first inclined portion,
when the pedestal position sensor detects that the pedestal is at a position where the height from the base to near the bottom of the inclined surface of the first inclined portion is greater than the height from the base to the contact area between the cam portion and the inclined surface of the first inclined potion, the rotary drive unit rotates the tip end of the support portion in a vertical direction.

4. The lifting mechanism according to claim 2, wherein
the second inclined portion includes plural and adjacent each other, each of the second inclined portions includes: a shaft hole parallel to an edge on one of the edge of the inclined surface; and a shaft portion parallel to the edge on the another of the edge of the inclined surface,
when the contact part of the second inclined portion is supported in the vertical direction at the tip end of the support portion, the inclined surfaces of all the second inclined portions form a same plane.

5. The lifting mechanism according to claim 3, wherein
the second inclined portion includes plural and adjacent each other, each of the second inclined portions includes: a shaft hole parallel to an edge on one of the edge of the inclined surface; and a shaft portion parallel to the edge on the another of the edge of the inclined surface,
when the contact part of the second inclined portion is supported in the vertical direction at the tip end of the support portion, the inclined surfaces of all the second inclined portions form a same plane.

6. The lifting mechanism according to claim 1, wherein
the regulator is located at a bottom of the table.

7. The lifting mechanism according to claim 6, further comprising:
a telescopic arm including first and second lift arms mutually rotatably connected between the base and the table, the telescopic arm being extendable by the pedestal: and
a link portion extending the telescopic arm up and down, wherein
one end of the first and second lift arms is moveable horizontally by a guide rail,
when the table is in a lowest position, the pedestal and the link portion are not connected,
when a lifting operation of the table by the lifting unit is completed, the pedestal is connected to the link portion.

8. The lifting mechanism according to claim 6, further comprising:
a telescopic arm including first and second lift arms mutually rotatably connected between the base and the table, the telescopic arm being extendable by the pedestal; and
a link portion extending the telescopic arm up and down, wherein
one end of the first and second lift arms is moveable horizontally by a guide rail, the guide rail is located on the pedestal,
when the table is in a lowest position, an end of the guide rail is not connected to an end of the first lift arm,
when a lifting operation of the table by the lifting unit is completed, the end of the guide rail and the end of the first lift arm are connected.

9. The lifting mechanism according to claim 6, further comprising:
a telescopic arm including first and second lift arms mutually rotatably connected between the base and the table, the telescopic arm being extendable vertically by an extension of the driver with respect to the pedestal, wherein
one end of the first and second lift arms is moveable horizontally by a guide rail,
one end of the driver is connected to one shaft of the first lift arm, and the pedestal is connected to the other end of the driver,
a stopper configured to restrict horizontal movement of the pedestal is provided between the driver and the pedestal,
when the table is in a lowest position, the pedestal and the stopper are not connected,
when a lifting operation of the table by the lifting unit is completed, the pedestal is contact with the stopper.

10. The lifting mechanism according to claim 6, wherein
the regulator is a cylinder structure.

11. The lifting mechanism according to claim 1, wherein
the driver is at least one of a hydraulic cylinder driven, a screw driven, a wire driven, and an air driven.

12. The lifting mechanism according to claim 1, wherein
when the table is in a lowest position, the inclined portion is in contact with the base.
